(19) United States
(12) Patent Application Publication
(10) Pub. No.: US 2019/0187810 A1
(43) Pub. Date: Jun. 20, 2019

(54) ACTIVE STYLUS APPARATUS AND METHOD

(71) Applicant: Tactual Labs Co., New York, NY (US)

(72) Inventors: Robert Alack, JR., Austin, TX (US); Ron Ship, Austin, TX (US); Tom Jose, Austin, TX (US); Braon Moseley, Round Rock, TX (US); Dan Morelli, Georgetown, TX (US); Mark Bisbee, Los Gatos, CA (US)

(73) Assignee: Tactual Labs Co., New York, NY (US)

(21) Appl. No.: 16/209,265

(22) Filed: Dec. 4, 2018

Related U.S. Application Data
(60) Provisional application No. 62/594,502, filed on Dec. 4, 2017.

(51) Int. Cl. G06F 3/038; G06F 3/0354; G06F 3/041; G06F 3/044

(52) U.S. Cl. CPC G06F 3/038; G06F 3/03545; G06F 2203/04108; G06F 3/044; G06F 2203/04104; G06F 3/0416

(57) ABSTRACT

A stylus system comprises a sensor having a plurality of first conductors and a plurality of second conductors. A receiver is associated with each of the first plurality of conductors and each of the second plurality of conductors. The stylus system has a signal processor configured to perform a Fast Fourier Transform on the signals received by the receivers during a plurality of successive interleaved touch integration periods and stylus integration periods. The system identifies touch events from the FFT of the signals received on the receivers during a touch integration period; and determines the location of a stylus, and information transmitted by the stylus from the FFT of the signals received on the receivers during a stylus integration period or a touch integration period.

This application claims the benefit of U.S. Provisional Application Serial No. 62/594,502, filed Dec. 4, 2017, the contents of which are hereby incorporated herein by reference.

### FIELD OF THE INVENTION

The disclosed apparatus and method relate in general to the field of stylus sensing systems, and in particular to an active stylus apparatus and method for implementing the active stylus.

### BACKGROUND

Touch sensitive devices are popular as input devices to various computing systems and other devices due to their ease of use and versatility. A touch sensitive device generally includes a touch surface which may, in various applications, be a clear translucent or opaque touch surface. In many applications (e.g., smart phones, smart watches, touch-screen tvs and touch-screen monitors) a clear touch surface includes a display device that enables a touch interface which, through appropriate software and hardware, allows a user to interact with the display. In other applications (e.g., touch pads) the touch surface does not include a display device that is viewed therethrough. Many methods and apparatus are known for measuring the touch deltas (e.g., the measurable change (i.e., response) resulting from a touch) and from those measurements, determining the location of one or more touches, see, e.g., U.S. Pat. No. 9,019,224, entitled “Low-Latency Touch Sensitive Device” and U.S. Pat. No. 9,158,411 entitled “Fast Multi-Touch Post Processing”, the disclosures of which are incorporated herein by this reference.

Touch delta may be expressed as a ratio in decibels (dB). Generally, the touch delta directly affects the signal-to-noise ratio (SNR) for the system. In a typical capacitive touch sensor design, high touch deltas are desirable at the touch surface of the sensor. Generally, a touch delta would reflect a difference between a baseline response of a touch sensor and its response with a touch object (such as a finger or stylus) present. In the context of the above-identified patents, a touch delta would reflect a difference between a baseline response of a touch sensor at each given frequency and its response at those frequencies with a touch object (such as a finger or stylus) present.

Portions of a touch sensor—which may be conductive materials such as ITO or silver nano-wire—are embedded, placed on, or integrated with a touch surface (such portions of a touch sensor may be referred to herein as e.g., conductors, conductive elements or antennas). First and second sets of touch sensor conductors are typically placed in a grid or crossing pattern (e.g., rows and columns), but in other configurations, such as those shown in U.S. patent application Ser. No. 15/690,234 (hereby incorporated herein by reference), the first and second sets of conductors (also referred to for convenience, not configuration, as rows and columns) need not intersect. Either the rows or columns may be stimulated with signals or energy, although in some embodiments, both the rows and columns are stimulated. In a typical touch application, spacing between the rows and spacing between the columns is generally uniform, and is often in the range of 4 mm to 5 mm, but it may be narrower or wider.

As used herein, driven conductors are sometimes referred to as drive lines (which may be rows or columns), and the conductors on which signals are received are sometimes referred to as sense lines (which may also be rows or columns). In some touch sensors, the touch sensor conductors may act as drive lines and sense lines at the same time, or at different times, see, e.g., U.S. Pat. No. 9,811,214 entitled “Fast Multi-touch Noise Reduction”, the disclosure of which is incorporated herein by this reference. Touch surfaces such as those described above may include an array of touch regions or nodes formed at the crossing points between rows of drive lines and columns of sense lines. To sense touch on the touch surface, while drive lines are stimulated with signals that capacitively couple with the sense lines, receivers are used to measure the coupled signals on the sense lines.

In some implementations, a touch causes coupled signals to decrease on the sense lines, and vice versa. It should be noted that the word touch as it is used herein does not require physical touch (e.g., actual contact), but only a nearing sufficient to create a measurable touch delta. In general, a touch sensitive device detects the position of touch deltas caused by a touch (i.e., a touch event) by correlating the receivers detecting the touch delta and the signals in which the touch delta appears to a position.

Although the rows and columns in some embodiments are referred to as “crossing”, the term crossing as used in that context is as observed from a plan view. In general, the rows and columns do not touch, rather, they are in sufficient proximity with each other that signals on one can be capacitively coupled to the other. In some implementations, the rows and columns are on separate layers. In some implementations, the rows and columns are on separate sides of a substrate. The rows and columns can be placed on the same layer, but can be bridged at each “crossing,” requiring a large number of such bridges. In some implementations, the rows and columns do not intersect and thus may be placed on the same layer.

Row-column configurations discussed above are easily etched or disposed on flat flexible surfaces and then applied to a surface. For flat surfaces, this works well, however, the use of flat-manufactured sensors on compound curves or on complex surfaces may cause a variety of issues including stretching and bunching, and may lead to breakage of conductors during, for example, a wrapping operation.

Stylus (a/k/a pen) instruments are used frequently today for interfacing with touch screens. There is an initiative to standardize stylus design called the Universal Stylus Initiative (USI). USI is working to develop and promote a specification for an active stylus. USI defines certain packet formats for communication of stylus information such as pressure, buttons, etc. The USI packets can be sent in both directions, uplink (from the USI controller to the pen via the sensor) and downlink (from the pen to the USI controller via the sensor). Once a beacon signal is sent from the USI controller, pens can respond in an allotted one or more of a fixed number of time slots. A drawback to the USI standards is increased latency because data must be sent during a data packet. Touch location and stylus data cannot be determined simultaneously when using only the USI standard.

There is a need for a stylus and stylus system that addresses the shortcomings of existing stylus interfaces.

### BRIEF DESCRIPTION OF THE DRAWINGS

The foregoing and other objects, features and advantages of the disclosure will be apparent to a person of skill in the art in view of this disclosure including each description of embodiments and as illustrated in the accompanying drawings, in which reference characters refer to the same parts throughout the various views. The drawings are not necessarily to scale, emphasis instead being placed upon illustrating principles of the disclosed embodiments.

FIG. 1 shows a high level illustration of the blocks in an illustrative embodiment of the component parts of a stylus.

FIG. 2 is a high level block diagram of various states of system operation for a stylus system.

FIG. 3 is a high level block diagram of a stylus system with an invert design with gain adjust.

FIG. 4 is a high level block diagram of a stylus system with an invert design with gain adjust and positive feedback intermediate.

FIG. 5 is a high level block diagram of a stylus system with a non-invert design with gain adjust.

FIG. 6 is a high level block diagram of a stylus system with a non-invert design with gain adjust and negative feedback intermediary.

FIG. 7 is a block diagram of a sensor system configured with a multiplexer in accordance with an embodiment of a stylus and sensor system disclosed herein.

### DETAILED DESCRIPTION

In various embodiments, the present disclosure is directed to systems (e.g., objects, panels or keyboards) sensitive to hover, contact and pressure and their applications in real-world, artificial reality, virtual reality and augmented reality settings. It will be understood by one of ordinary skill in the art that the disclosures herein apply generally to all types of systems using fast multi-touch to detect hover, contact and pressure. In an embodiment, the present system and method can be applied to panels and display surfaces.

Throughout this disclosure, the terms “touch”, “touches”, “touch event”, “contact”, “contacts”, “hover”, or “hovers” or other descriptors may be used to describe events or periods of time in which a stylus, key, key switch, user's finger, an object, or a body part is detected by a sensor. In some sensors, detections occur only when the user is in physical contact with a sensor, or a device in which it is embodied. In some embodiments, and as generally denoted by the word “contact”, these detections occur as a result of physical contact with a sensor, or a device in which it is embodied. In other embodiments, and as sometimes generally referred to by the term “hover”, the sensor may be tuned to allow for the detection of “touches” that are hovering at a distance above the touch surface or otherwise separated from the sensor device and causes a recognizable change, despite the fact that the conductive or capacitive object, e.g., a stylus or pen, is not in actual physical contact with the surface. Therefore, the use of language within this description that implies reliance upon sensed physical contact should not be taken to mean that the techniques described apply only to those embodiments; indeed, nearly all, if not all, of what is described herein would apply equally to “contact” and “hover”, each of which is a “touch”. Generally, as used herein, the word “hover” refers to non-contact touch events or touch, and as used herein the term “hover” is one type of “touch” in the sense that “touch” is intended herein. Thus, as used herein, the phrase “touch event” and the word “touch” when used as a noun include a near touch and a near touch event, or any other gesture that can be identified using a sensor. “Pressure” refers to the force per unit area exerted by a user contact (e.g., presses by their fingers or hand) against the surface of an object. The amount of “pressure” is similarly a measure of “contact”, i.e., “touch”. “Touch” refers to the states of “hover”, “contact”, “pressure”, or “grip”, whereas a lack of “touch” is generally identified by signals being below a threshold for accurate measurement by the sensor. In accordance with an embodiment, touch events may be detected, processed, and supplied to downstream computational processes with very low latency, e.g., on the order of ten milliseconds or less, or on the order of less than one millisecond.

As used herein, and especially within the claims, ordinal terms such as first and second are not intended, in and of themselves, to imply sequence, time or uniqueness, but rather, are used to distinguish one claimed construct from another. In some uses where the context dictates, these terms may imply that the first and second are unique. For example, where an event occurs at a first time, and another event occurs at a second time, there is no intended implication that the first time occurs before the second time, after the second time or simultaneously with the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristic. Thus, for example, a first and a second frequency, absent further limitation, could be the same frequency, e.g., the first frequency being 10 Mhz and the second frequency being 10 Mhz; or could be different frequencies, e.g., the first frequency being 10 Mhz and the second frequency being 11 Mhz. Context may dictate otherwise, for example, where a first and a second frequency are further limited to being frequency-orthogonal to each other, in which case, they could not be the same frequency.

The presently disclosed systems and methods involve principles related to and for designing, manufacturing and using capacitive based sensors, and particularly capacitive based sensors that employ a multiplexing scheme based on orthogonal signaling such as but not limited to frequency-division multiplexing (FDM), code-division multiplexing (CDM), or a hybrid modulation technique that combines both FDM and CDM methods. References to frequency herein could also refer to other orthogonal signal bases. As such, this application incorporates by reference Applicants' prior U.S. Pat. No. 9,019,224, entitled “Low-Latency Touch Sensitive Device” and U.S. Pat. No. 9,158,411 entitled “Fast Multi-Touch Post Processing.” These applications contemplate FDM, CDM, or FDM/CDM hybrid touch sensors which may be used in connection with the presently disclosed sensors. In such sensors, interactions are sensed when a signal from a row is coupled (increased) or decoupled (decreased) to a column and the result received on that column. By sequentially exciting the rows and measuring the coupling of the excitation signal at the columns, a heatmap reflecting capacitance changes, and thus proximity, can be created.

This application also employs principles used in fast multi-touch sensors and other interfaces disclosed in the following: U.S. Pat. Nos. 9,933,880; 9,019,224; 9,811,214; 9,804,721; 9,710,113; and 9,158,411. Familiarity with the disclosure, concepts and nomenclature within these patents is presumed. The entire disclosure of those patents and the applications incorporated therein by reference are incorporated herein by reference. This application also employs principles used in fast multi-touch sensors and other interfaces disclosed in the following: U.S. patent applications Ser. Nos. 15/162,240; 15/690,234; 15/195,675; 15/200,642; 15/821,677; 15/904,953; 15/905,465; 15/943,221; 62/540,458, 62/575,005, 62/621,117, 62/619,656 and PCT publication PCT/US2017/050547, familiarity with the disclosures, concepts and nomenclature therein is presumed. The entire disclosure of those applications and the applications incorporated therein by reference are incorporated herein by reference.

The novel active stylus and method for its operation may be used in connection with a sensor (e.g., a touch sensor) having a surface comprising row conductors and column conductors that are not in ohmic contact with one-another. The row conductors and column conductors may be on separate substrates, opposing sides of a single substrate, or on the same side of substrate. Where the row and column conductors are on the same side of a substrate, ohmic contact may be avoided by bridges, or the rows and columns may be organized such that they do not overlap, and thus require no bridges.

Where the sensor employed is a touch sensor, the sensor system may include a signal generator to generate drive signals on one set (e.g., rows or columns) of conductors and a receiver to detect signals on the other set (e.g., columns or rows) of conductors. In an embodiment, one or more signal generators generate drive signals on both sets of conductors. In an embodiment, one or more signal generators generate drive signals on both sets of conductors simultaneously. In an embodiment, one or more signal generators generate drive signals on one set of conductors at a time, but a multiplexer can direct such drive signals to either the rows or the columns. In an embodiment, one or more receivers receive signals on both sets of conductors. In an embodiment, one or more receivers receive signals from both sets of conductors simultaneously. In an embodiment, one or more receivers receive signals on one set of conductors at a time, but a multiplexer can direct such signals to one or more receivers from either the rows or the columns.

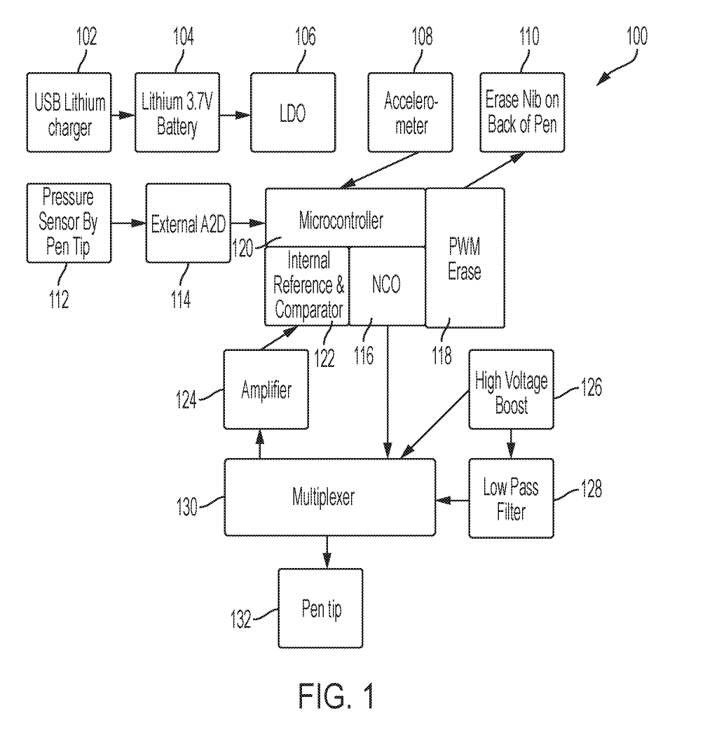

FIG. 1 shows a high level illustration of the functional blocks in an illustrative embodiment of the component parts of a stylus 100. It should be understood that other components or fewer components may be used as part of a stylus 100 depending on the requirement and specifications of the sensor system in which the stylus 100 is to be employed. The stylus 100 may have a USB lithium charger 102. The USB lithium charger is able to use USB outlets in order to charge a lithium 3.7 V battery 104. The lithium 3.7 V battery 104 may be operably connected to a low dropout regulator (LDO) 106. LDO 106 is a DC linear voltage regulator that can regulate the output voltage even when the supply voltage is very close to the output voltage.

The stylus 100 may also have an accelerometer 108 that is operably connected to a microcontroller 120. The accelerometer 108 is able to detect changes in motion made by the stylus 100 during usage of the stylus 100. The changes measured by the accelerometer 108 can transformed by the microcontroller 120 into a signal that is able to be transmitted by the stylus 100 to the sensor system during one of the integration periods discussed below.

The stylus 100 may also have an erase nib 110 that is operably connected to a pulse width modulation erase 118 component and microcontroller 120. The erase nib 110 may be located on the back of the pen. The erase nib 110 is able to erase marks that have been made and/or that exist on the display. The erase nib signal is able to be transmitted by the stylus 100 to the sensor system during one of the integration periods discussed below. In an embodiment, the erase nib signal is frequency orthogonal to each other signal emitted by the stylus.

The stylus 100 may also have a pressure sensor 112 that may be located near the tip of the stylus 100. The pressure sensor 112 may be operably connected to an AD2 114 (which is a two-channel power amplifier). The pressure sensor 112 or the AD2 114 may be operably connected to a microcontroller 120. The pressure sensor 112 is able to detect changes in pressure made by the stylus 100 during usage of the stylus 100. The changes measured by the pressure sensor 112 can be transformed by the microcontroller 120 into a signal that is able to be transmitted by the stylus 100 to the sensor system during one of the integration periods discussed below.

The microcontroller 120 is operably connected to an internal reference and comparator 122 and a numerically controlled oscillator (NCO) 116. The internal reference and comparator 122 and the NCO 116 are able to be used to generate a signal that is to be transmitted to the sensor. The microcontroller 120 is able to process information taken from the accelerometer 108, the erase nib 110 and the pressure sensor 112 in order to generate the appropriate signals via the internal reference and comparator 122 and the NCO 116.

The microcontroller 120 and its associated components are operably connected to an amplifier 124, a high voltage boost 126, a low pass filter 128 and a multiplexer 130 which are then in turn connected to a pen tip 132. The signals that are generated by the stylus 100 are transmitted to a sensor via the pen tip 132.

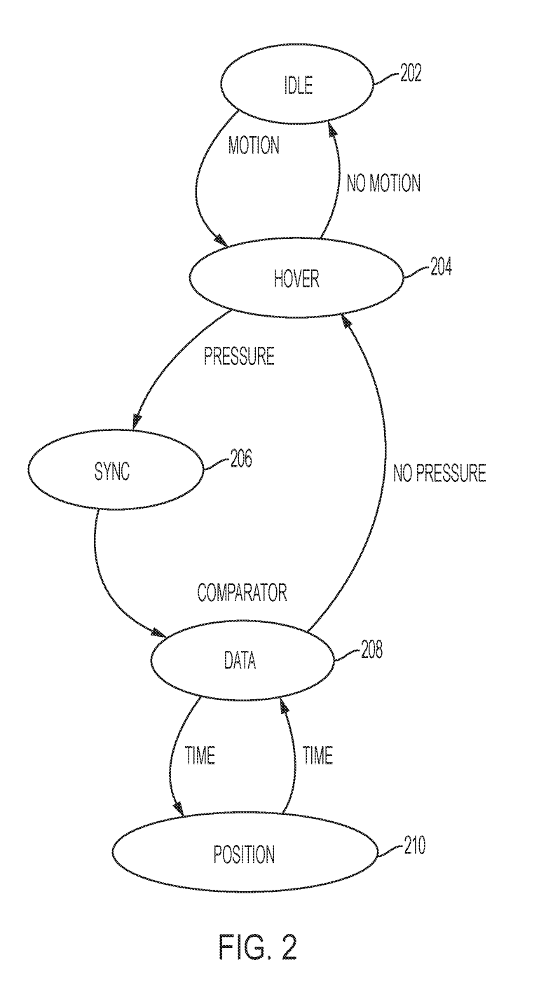

FIG. 2 is a high level block diagram of various states of system operation for a stylus system. The flow chart shows the movement of steps from an idle state to the motion of the pen. In step 202 there is an idle state for the stylus. During the idle state it is determined if there is motion or no motion of the stylus. The motion of the stylus can be determined based on use of sensors within the stylus, such as an accelerometer. In an embodiment, the motion of the stylus is determined based on reception of signals on the touch sensor.

In step 204 the stylus moves from the idle state to hover. Hover is a state that is above the surface of a touch sensor but not in contact with the surface of the touch sensor. Based on the determination of a hover state, the touch sensor and programming thereon may respond.

In step 204 it is determined if there is pressure or no pressure by the stylus. The pressure of the stylus may be determined by a pressure sensor. In an embodiment, the pressure of the stylus is determined by the sensed movement of the stylus by the touch sensor. In an embodiment, the pressure of the stylus is determined by a predictive determination made by the stylus. In an embodiment, the pressure of the stylus is determined based on the pressure sensors located on the body of a stylus.

If there is pressure being exhibited by the stylus, the stylus system may move to a sync step 206 where the stylus is synced with the sensor system and a comparator will adjust the respective signal strength to correspond with the sensor system and the sensed pressure. By syncing the stylus with the touch sensor, the signals transmitted from the stylus will be in phase or alternatively the phase of the signals transmitted by the stylus may be adjusted in response to the received signals from the touch sensor. So for instance, the stylus may use data received from the touch sensor in order to invert the signals from the stylus so that they are 180 degrees out of phase with respect to a signal that is transmitted on the touch sensor. The inversion of the phase of the signals transmitted from the stylus will make the stylus signals transmitted from the stylus appear differently to the touch sensor.

In step 208 data from the stylus is transmitted to the touch sensor. In step 210 the position of the stylus can be ascertained and correlated with a specific time by the stylus system.

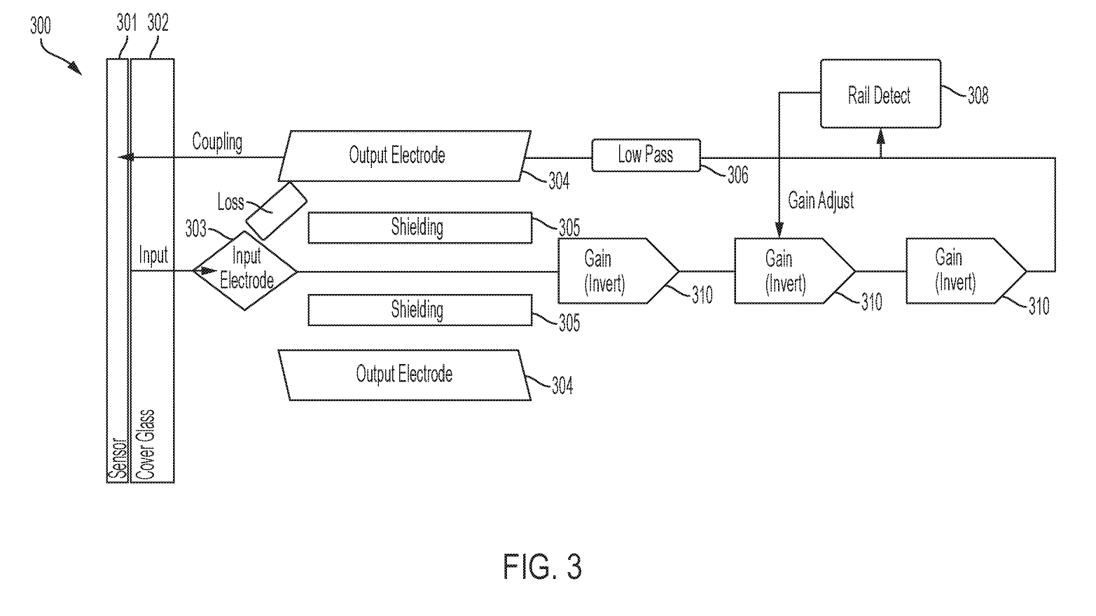

FIGS. 3-6 show diagrams of active styluses. The active styluses shown use invert and non-invert designs. The use of an invert design with gain adjust is able to amplify and enhance the amount of signal that is impacted by the presence of the active stylus and the signal that is transmitted to a touch sensor. The use of the term “invert” herein and in the diagrams shown in FIGS. 3-6, means that the frequencies that are transmitted on the touch sensor and received by the stylus are phase shifted by 180 degrees. In an embodiment, in addition to inverting the phase of the of the received signals the signals are amplified. By amplifying and phase shifting the signals that are transmitted back to the touch sensor, the touch sensor is able to perceive the received signals with more clarity, i.e, the received signals appear stronger.

To distinguish between a touch or the use of a stylus on a touch sensor. The touch sensor scans for the unique signal that is transmitted by an active stylus on the row and column conductors. If there is more than one stylus it may be difficult to distinguish between the two when they are at the same location. By using “non-invert” designs the frequencies and phases proximate to the tip of the stylus can be taken and amplified in a way so that they are at 0 phase offset. The result of the 0 phase offset is that there is a positive displacement of the signals received by the touch sensor. Touches will provide a negative displacement, stylus signals will provide a positive displacement. This makes distinguishing the respective signals easier.

When syncing the styluses either the invert or non-invert techniques can be employed. Alternatively, instead of having the stylus receive the signals proximate to the tip and re-transmitting them with gain and/or phase offset, the stylus may be synced to the screen. After syncing to the screen, three or five sensor bins can be created. After creation of these three or five sensor it is possible to create negative displacement and/or positive displacement and therefore would not require a separate frame for the stylus.

Returning to the invert and non-invert stylus technique, FIG. 3 is a high level block diagram of a stylus system with an invert design with gain adjust for the stylus employed in the system. The stylus system 300 has a sensor 301 and cover glass 302. The sensor 301 is made of the row conductors and column conductors, as discussed above. The stylus comprises an input electrode 303 that is able to detect and receive signals from the sensor 301. The signals received are those signals that transmitted either down the row conductors and/or the column conductors used by the sensor 301. Signals received from the input electrode 303 are transmitted to a series of invert gains 310. The series of invert gains 310 may be operably connected to a rail detect 308 and low pass filter 306.

Further formed as part of the stylus is the output electrode 304 that is able to output signals to the sensor 301. Shielding 305 surrounds the conductors that transmit signals from the input electrodes 303 so that the input signals and the output signals do not impact or interfere with each other.

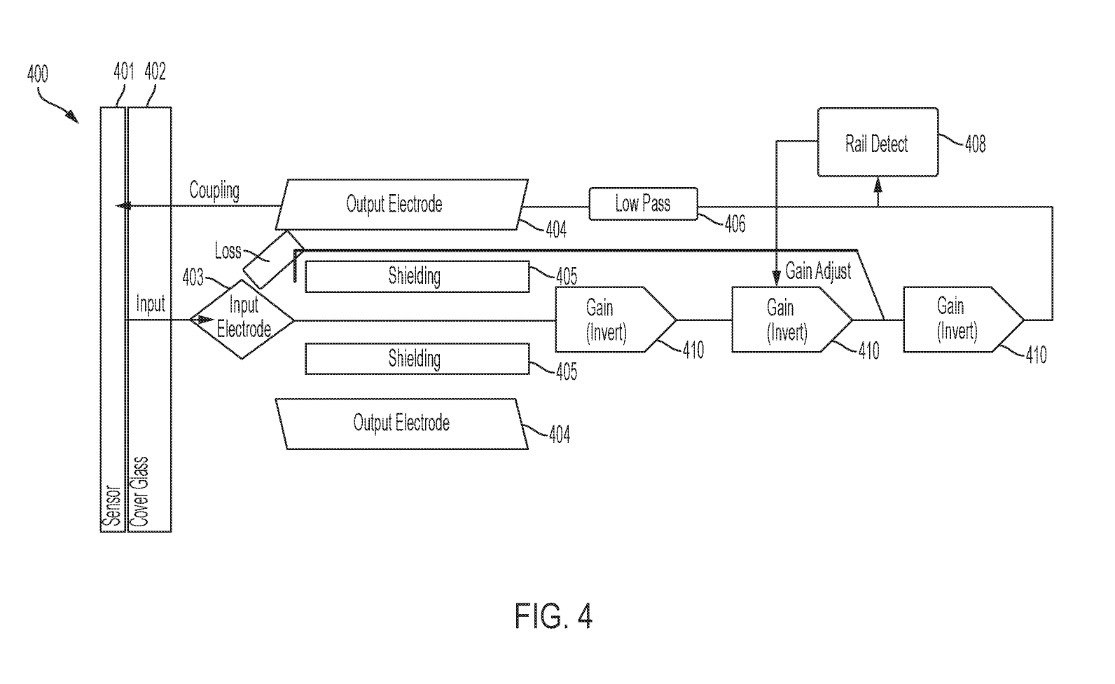

FIG. 4 is a high level block diagram of a stylus system with an invert design with gain adjust and positive feedback for the stylus. The stylus system 400 has a sensor 401 and cover glass 402. The sensor 401 may be made of the row conductors and column conductors, such as discussed above. The stylus comprises an input electrode 403 that is able receive and detect signals from the sensor 401. The received signals are those signals that are transmitted by either or both the row conductors and the column conductors.

Further formed as part of the stylus is an output electrode 404 that is able to output signals to the sensor 401. Shielding 405 surrounds the conductors that transmit signals from the input electrode 403 so that they are not impacted from noise from the output electrodes 404. Signals received from the input electrode 403 are transmitted to invert gains 410, which are operably connected to the rail detect 408 and low pass filter 406. An additional connection between the invert gains 410 and the input electrode 403 is able to provide positive feedback with respect to signals that are transmitted from the input electrode 403.

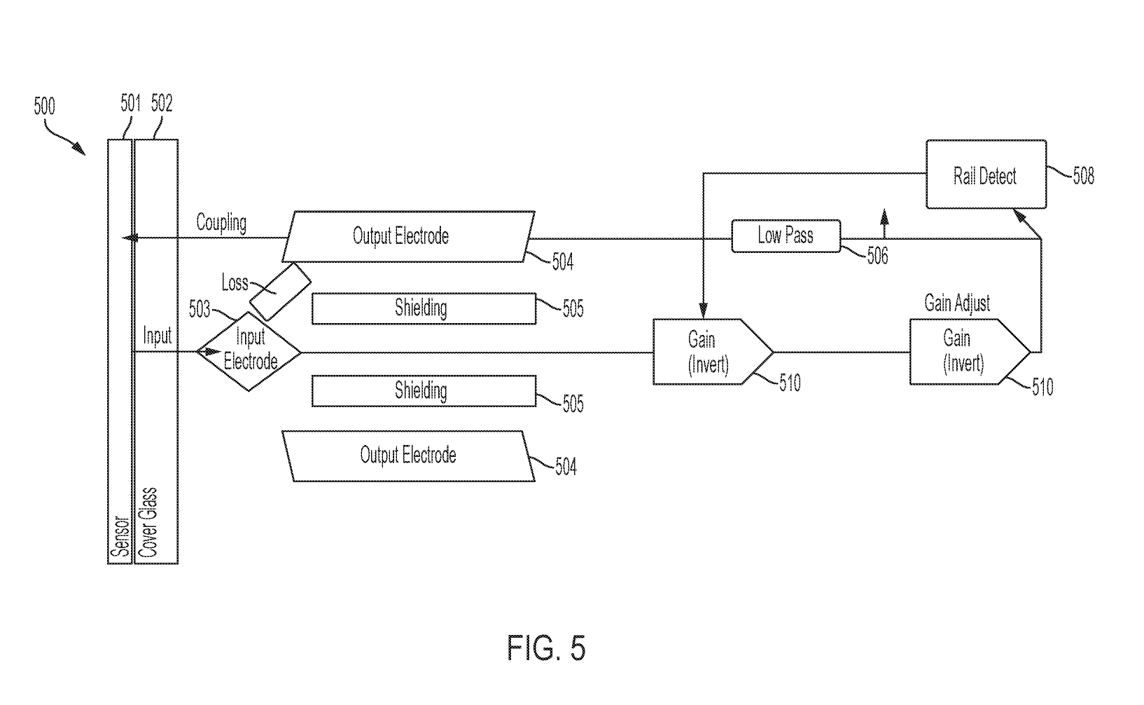

FIG. 5 is a high level block diagram of a stylus system with a non-invert design with gain adjust for the stylus. The stylus system 500 has a sensor 501 and cover glass 502. The sensor 501 is made of the row conductors and column conductors, as discussed above. The stylus comprises an input electrode 503 that is able to detect and receive signals from the sensor 501 that are transmitted on the row conductors and column conductors. Further attached to the stylus is the output electrode 504 that is able to output signals to the sensor 501. Shielding 505 surrounds the connections that transmit signals from the input electrodes 503 so that they are not impacted by or impact signals from the output electrode 504. Signals received from the input electrode 503 are transmitted to invert gains 510, which are operably connected to the rail detect 508 and low pass filter 506. In this embodiment, the stylus system 500 only employs two invert gains 510 so as to have a non-invert design.

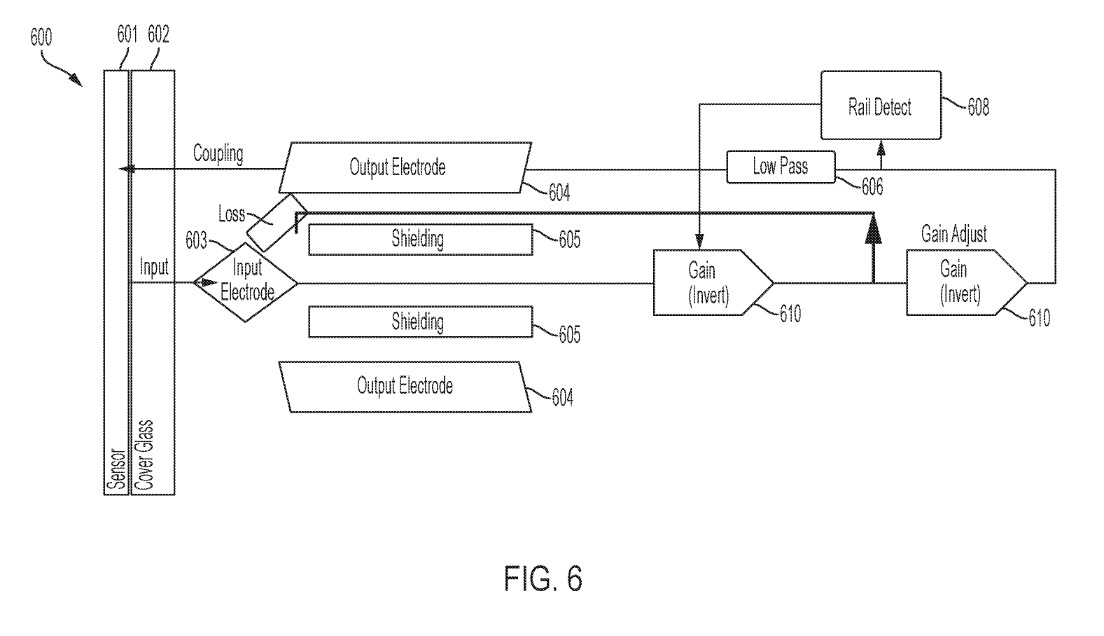

FIG. 6 is a high level block diagram of a stylus system with a non-invert design with gain adjust and intermediary negative feedback for a stylus. The stylus system 600 has a sensor 601 and cover glass 602. The sensor 601 is made of the row conductors and column conductors, as discussed above. The stylus comprises an input electrode 603 that is able to detect and receive signals from the sensor 601 that are detected and received from either or both the row conductors or the column conductors.

Further attached to the stylus is an output electrode 604 that is able to output signals to the sensor 601. Shielding 605 surrounds the connections that transmit signals from the input electrode 603 so that they are not impacted by signals from or to the output electrodes 604. Signals received from the input electrode 603 are transmitted to invert gains 610, which are operably connected to the rail detect 608 and low pass filter 606. An additional connection between the input electrode and the invert gain 610 is able to provide negative feedback with respect to signals that are transmitted from the input electrode 603. The stylus system 600 only employs two invert gains 610 so as to have a non-invert design.

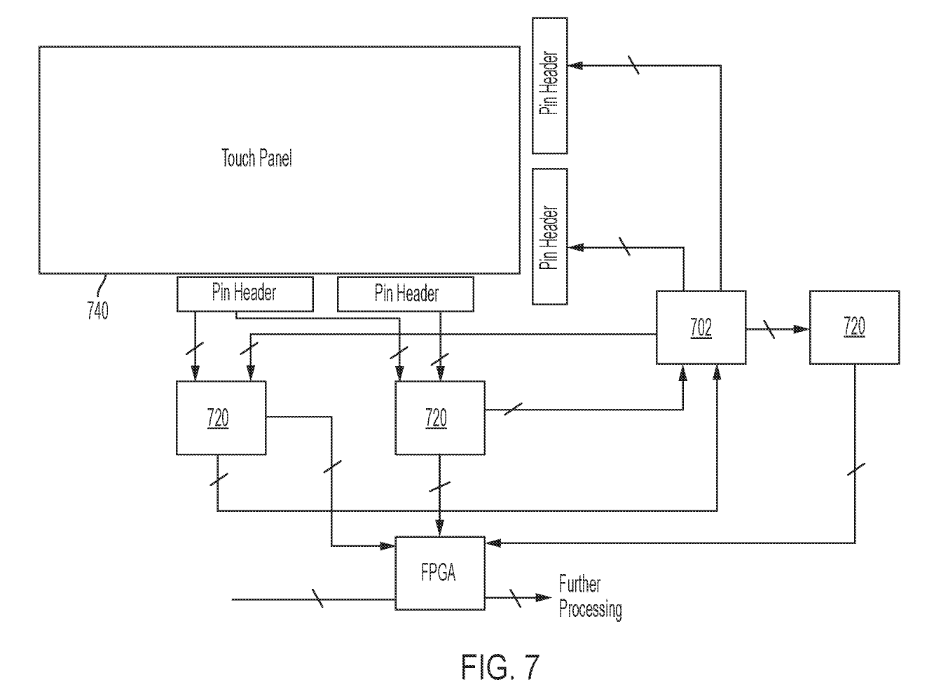

FIG. 7 is a block diagram of a touch panel 740 used with the sensor and stylus system. A multiplexer 702 and processors 720 may be employed with styluses and the touch panel, such as those discussed above. The system may employ a number of processors 720 that are able to generate and process the signals that are transmitted and received via the touch panel 740. A multiplexer 702 further assists in the receipt and transmission of signals via the touch panel 740 and processed by the processors 702. Signals received and processed by the processors are ultimately further processed by the system to output data to the system display.

In an embodiment, a signal generator is used to generate a plurality of orthogonal signals that are transmitted down the row conductors and/or column conductors to the touch panel 740. In an embodiment, the signal generator is used to generate a plurality of orthogonal frequency signals that approximate a sine wave. In an embodiment, each row conductor and/or column conductor on which a signal is transmitted is provided a unique signal that is frequency orthogonal to the signal on each other row or column conductor upon which a signal is transmitted. In an embodiment, one or more receiver is used to detect signals on row and/or column conductors, and to determine touch based on the sensed signals.

In an embodiment, the signals received are transformed into the frequency domain. In an embodiment, the signals received are processed using a Fourier transform. In an embodiment, the signals received over an integration period are processed using a discrete Fourier transform. In an embodiment, the signals received over an integration period are processed using a discrete Fast Fourier Transform (i.e., FFT). Using an FFT on the samples taken during a measurement period results in providing values in each of a plurality of bins. The number of bins is related to the sampling rate and the integration period.

For example, an integration time may be 512 uSec, i.e., a 512 uSec measurement period. Using a 4 MHz sampling rate, which yields 4 mega-samples per second (mSps), taking 2048 samples will take 0.0005 seconds, or roughly 512 uSec. The bin spacing of the FFT will be 4 MHz divided by the 2048 samples, or about 2 KHz (or more precisely, 1.953125 KHz). The resulting FFT will have 1024 bins separated from each other by 1.953125 KHz. It will be apparent to a person of skill in the art that higher or lower sampling rates can be used, more or fewer samples can be taken, and a longer or shorter integration period can be used. Other things being equal, higher sampling rates will cause wider bin spacing. And there is a trade-off between the integration period—which corresponds to the inverse of a maximum number of frames of touch data per second—and the bin depth and spacing.

In an illustrative embodiment, a touch panel is provided that has 68 row conductors and 121 column conductors. (Where row conductors and column conductors had approximately 5 mm spacing, 68×121 correspond to approximately a 27″ screen.) In this illustrative embodiment, each row conductor is connected to a transmitter, and each column conductor is connected to a receiver. In this illustrative embodiment, during an integration period (i.e., measurement period) a different orthogonal frequency is transmitted on each of the row conductors. In this illustrative embodiment, the signals received by the receivers are sampled at 4 MHz. In this illustrative embodiment, 2048 samples are taken at each receiver, and an FFT performed thereupon. In this illustrative embodiment, there are 1024 FFT bins, each corresponding to a frequency, however, only 68 bins are necessary for interpreting touch data in the 68 unique row signals, leaving 956 bins that are not required.

In some embodiments, multiple orthogonal frequencies are required on one or more row conductors, or even on each row conductor. In some embodiments, one or more orthogonal frequencies are also required on one column conductor, or even on each column conductor. In an embodiment where two frequencies were used on each row conductor, and simultaneously, two frequencies were used on each column conductor, the illustrated embodiment would still leave 1024−(2*68)+(2*121)) or 646 bins that are not required.

In an embodiment, bins that are not utilized for touch can be used by a stylus to provide information through a sensor. A stylus may communicate information concerning button presses, contact, pressure, tilt and/or rotation. In an embodiment, a stylus comprises a capacitive touch interface (e.g., 3 or more column conductors running the length of the stylus and a number of row conductors (e.g. every 5 mm) circumscribing the width of the stylus in a gripping area), and may communicate raw or processed touch information from that touch interface through a sensor. In an embodiment, a stylus comprises a capacitive touch interface that can determine information about how it is being held, or used, and may communicate information about how it is being held or used through a sensor. In an embodiment, a stylus comprises a capacitive touch interface and software to determine a skeletal model of the gripping hand, and may communicate the skeletal model through a sensor.

In another illustrative embodiment, using a touch screen that has 68 rows and 121 columns, and an integration period of 512 uSec, the signals received by the receivers are sampled at 8 MHz and thus, 4096 samples are taken at each receiver. After an FFT is performed, there are 2048 bins, each corresponding to a frequency, and thus 1980 available for a stylus to use to communicate through a sensor.

In an embodiment, the stylus may include one or more receivers to receive signals that are being driven into conductors on the sensor. In an embodiment, the sensor has a touch integration period (TIP) and a stylus integration period (SIP). In an embodiment, during a TIP, signals are transmitted on rows, and signals are received on columns, while during a SIP, signals are received on rows and columns. Such a configuration provides stylus information (during SIP) without noise that may be caused by the transmitters.

In an embodiment, during the TIP each drive line (e.g., row conductor) is driven with a different signal, and the signals on each sense line (e.g., column conductor) are sampled and processed, to determine touch. In an embodiment, during the SIP, each row conductor and column conductor may be used as a sense line, and the signals on each are sampled and processed to determine information sent by the stylus through the sensor. In an embodiment, the TIP and SIP are each a period of the same length (e.g., 512 uSec), and the sampling takes place at the same sampling rate (e.g., 4 MSps). In an embodiment, the TIP and SIP are interleaved so that each follows the other. In an embodiment, multiple TIPs may occur between two SIPs. In an embodiment, multiple SIPs may occur between two TIPs. In an embodiment, TIPs or SIPs may be followed by a period during which sampling is not done, e.g., to permit processing of the sampled data to complete. For example, in an embodiment, an FFT of the samples may take over 600 uSec, then a short period of waiting (e.g., over 100 uSec) may exist after each SIP or TIP, to prevent an overflow of data. In an embodiment, the period required to process the signals (e.g., the FFT) should not be shorter than the period between starting one TIP or SIP and the next TIP or SIP. Thus, if the FFT takes 600 uSec, a system could operate having a TIP begin at time 0, and a SIP begin 600 uSec later, and another TIP begin 600 uSec later again, etc.

In an embodiment the sensor has a first combined integration period (FCIP) and a second combined integration period (SCIP), during the FCIP, each drive line (e.g., row conductor) is driven with a different signal, and the signals on each sense line (e.g., column conductor) are sampled and processed, to determine touch and to determine information sent by the stylus through the sensor; during the SCIP, each row is sampled and processed, to determine information sent by the stylus through the sensor. Optionally, during the SCIP, each column conductor can be driven with a different signal, and the sampled row conductors can be processed to also determine touch.

The FCIP and SCIP, like the TIP and SIP, may have varied sampling rates and FFT depth. Also like the TIP and SIP, the FCIP and SCIP may be interleaved. The advantage of the FCIP/SCIP is that touch can be measured in every integration period. The advantage of the TIP/SIP is that pen x and pen y are determined during the same integration period.

In an embodiment, a multiplexer is used to switch the connection between transmitters (e.g., signal generators) and receivers, and the row and column conductors. In an embodiment, during a TIP, a multiplexer connects the transmitters to the row conductors, while during the SIP the multiplexer connects receivers to the row conductors. In an embodiment, during the FCIP a multiplexer connects the transmitters to the row conductors and the receivers to the column conductors, while during the SCIP, the multiplexer connects the transmitters to the column conductors and the receivers to the row conductors.

It will be apparent to a person of skill in the art that an integration period (TIP/SIP/FCIP/SCIP) can be selected to accommodate various parameters of a system including the touch delta and noise (e.g., from the display panel). The desired signal-to-noise ratio (SNR) for the touch and/or stylus drives decision making on speed. Longer integration periods yield better SNR.

Additionally, to further complement the TIP, SIP, FCIP or SCIP, there can be an additional integration period that can exist supplementing the integration periods that detect either stylus or touch. A financial device, such as a bank card, or a smartphone, may also have implemented within it a transmitter that is able to transmit a signal that is indicative of a numerical sequence associated with the user's account. A user would be able to have the financial card read by a sensor surface during the additional integration period or during one of the combined integration periods. In an embodiment, the financial device is able to transmit a signal during the stylus integration period in addition to the signals transmitted by the stylus.

In an embodiment there is a device integration period (DIP) separate from the TIP or SIP that is dedicated to receiving signals from the device. In an embodiment the financial device is able to transmit a signal during the touch integration period. In an embodiment the DIP is interleaved between the TIP and the SIP, where there is a TIP, a DIP, an SIP, then a DIP. In an embodiment, there is a TIP, a TIP, an SIP, then a DIP. In an embodiment there is a TIP, an SIP, an SIP, then a DIP. In an embodiment, the DIP comes every fifth integration period. In an embodiment, the DIP comes every tenth integration period. In an embodiment, the DIP comes every one-hundredth integration period. In an embodiment the integration period comes every one-thousandth integration period.

In addition to the financial devices, other devices or mobile phones can have transmitters that are able to transmit a signal and have that signal read through the touch screen surface. In an embodiment, contact information is delivered directly through interaction with the touch screen display. In an embodiment, documents, presentations and other digital information are delivered directly through the touch screen display. In an embodiment, identification information is delivered directly through the touch screen display. In an embodiment, a digital key is delivered directly through the interaction with the touch screen display.

### Stylus Configuration

In an embodiment, a stylus comprises a signal generator or transmitter that may generate at least one signal (or an approximation of that signal) within the bin-space of the sensor FFT. In accordance with one embodiment, a stylus comprises a signal generator or transmitter that may generate at least one signal (or an approximation of that signal) such that it corresponds to a bin on the sensor FFT. In an embodiment, the stylus also contains one or more buttons, switches, dials or sensors. In an embodiment, the stylus comprises a proximity sensor that measures its proximity to the screen. In an embodiment, the stylus comprises a touch sensor that detects touch on the stylus. In an embodiment, the stylus comprises a touch sensor that detects touch on the stylus and further comprises a touch processing engine that can determine at least one of the following: touching of the stylus, grip on the stylus, skeletal orientation of a hand in touch with the stylus. In an embodiment, the stylus comprises a stylus ID or a memory containing a stylus ID. In an embodiment, the stylus ID may be unique to the stylus. In an embodiment, the stylus ID may be in a rewritable memory. In an embodiment, the stylus ID may be associated with at least one of the following: stylus color; stylus color palate; stylus line weight; stylus line weight palate; stylus configuration; and stylus identification.

In an embodiment, the stylus is configured to send information about its state, sensors, memory, or information it processed to the sensor, and thereby through the sensor. In an embodiment, tilt, rotation and skeletal model information as determined by the stylus is sent to the sensor, and thus to a sensor controller. In an embodiment, tilt, rotation and skeletal model information as determined by the stylus is sent to the sensor, and thus to a sensor controller for use in aiding palm rejection.

In an embodiment, the stylus has a tip or other conductor from which it can transmit one or more signals. In an embodiment, the stylus includes a plurality of tips or conductors from which it can transmit one or more signals. For example, a stylus may include a conductor on each end (e.g., a writing tip and an eraser).

In an embodiment, a signal source (e.g., signal generator) is operatively connected to the tip and/or other transmit conductors and configured to transmit one or more signals via the tip. In an embodiment, an NCO (numerically controlled oscillator) can be as a component of the signal source to generate a periodic signal. In an embodiment, a signal is generated using a VCO (voltage controlled oscillator). In an embodiment, a signal is generated using another type of signal generator. In an embodiment, a signal source can produce a signal having multiple frequencies by combining the output of more than one NCO. In an embodiment, a DAC can be used as a component of the signal source. In an embodiment, the stylus can provide a sequence of numbers to the DAC, the sequence of numbers corresponding to one frequency, or to multiple frequencies. In an embodiment, the stylus includes a microprocessor that generates numbers that are supplied to the DAC, the microprocessor generated numbers corresponding to one frequency, or to multiple frequencies. In an embodiment, a 555 type timer IC can generate a periodic signal. In an embodiment, an oscillator with a PWM can generate a periodic signal. In an embodiment a resistor set oscillator (e.g. LTC6906) can be used to generate a periodic signal.

In an embodiment, a stylus can have multiple frequency generators. In an embodiment, the output of multiple frequency generators are combined with an op-amp voltage adder. In an embodiment, the output of multiple frequency generators are combined with a logical AND gate.

In an embodiment, rather than having circuitry for multiple frequency generators, multiple frequencies can be combined in software and a single DAC could be employed to transmit them all. In an embodiment, an NCO-like circuit could be configured to accept two (or more) frequencies and to output a combination (e.g., sum) of the two.

As described above, a stylus is provided that includes a capability to transmit one or more frequencies from a tip, and has one or more kinds of information that can be provided to a system through the sensor. Also as described above, the sensor is configured to implement a SIP, or a FCIP and SCIP during which it will receive data that it will associate with the stylus. Moreover, the sensor is configured to sense a plurality of frequencies e.g., corresponding to bins from an FFT calculation, that are reserved for stylus communications. In an embodiment, the sensor is a touch sensor and is configured to sense a broad set of frequencies corresponding to FFT bins, but uses only a subset of the broad set of frequencies for detection of touch, and accordingly, has another subset of the broad set of frequencies that can be used by one or more stylus, What follows are a variety of methods that can be used for communicating information from a stylus to the sensor. These methods can be used exclusively or in combination with each other to communicate information from the stylus to the sensor.

Except as indicated otherwise, it should be understood that the orthogonal signals (e.g., frequencies) referred to in connection with the following methods and stylus systems are not required by the sensor for other purposes. In an embodiment, the stylus may be synchronized with the sensor, and thus, can limit its use of the orthogonal signals to the SIP, thus allowing reuse of the signals during the TIP for other purposes. In an embodiment, the stylus is asynchronous with the sensor in the sense that it may continuously use the stylus orthogonal signals without interfering with the operations of the sensor, e.g., the stylus orthogonal signals (SOS) are not used by the sensor for sensing other than sensing of, and receiving information from, the stylus. It should be noted that that the use of the term frequencies below can be interchanged with other orthogonal signals, such as, e.g., code orthogonal signals.

In an embodiment, following an SIP, or each FCIP/SCIP an FFT is performed on the signals received on every row and every column. To the extent the values in bins corresponding to SOS are above a detection threshold, a stylus is determined to be in proximity to the row conductor or column conductor on which the SOS is found. In an embodiment, during an SIP, all row conductors and column conductors are in receive mode, thus, the row conductors and column conductors where threshold-exceeding SOS is found correspond to, or can be used to determine, the position of a stylus. In an embodiment, during an FCIP/SCIP pair, all row conductors and column conductors are in receive mode for an integration period, thus, the row conductors and column conductors where threshold-exceeding SOS is found correspond to, or can be used to determine, position of a stylus. As discussed below, information communicated from the stylus through the sensor can be determined by analysis of SOS bin content.

The result of an FFT may be a real and imaginary component, sometimes referred to as in-phase (I) and quadrature (Q) components. In an embodiment, instead of looking at both components of a bin, the square-root of the sum of the squares of I and Q can be used. In an embodiment, because a square-root computation is computationally expensive, the sum of the squares of the I and Q can be used instead.

### One Bit Per Bin

In an embodiment, a stylus can select an SOS, and the selected SOS can communicate stylus information. In an embodiment, a stylus has information concerning its orientation or use that may be communicated via the sensor, and selects an SOS that corresponds to that information. As an illustrative example, consider a sensor that reserves an SOS space of 956 bins as described above in connection with an embodiment of a 27″ screen. In an embodiment, these bins are bin 0 through bin 955. In an embodiment, a predetermined decision is made to communicate a stylus pressure measurement using a fixed set of bins, e.g., bins 0 through 127. A stylus could communicate any of 128 different measurements by selecting a frequency corresponding to the bin reflecting the measurement. For example, the stylus could transmit a frequency corresponding to bin 0 to reflect no pressure, and a frequency corresponding to bin 127 to reflect maximum pressure.

In an embodiment, a predetermined decision is made to communicate a stylus tilt measurement using a fixed set of bins, e.g., bins 128 through 256. A stylus could communicate any of 128 different measurements by selecting a frequency corresponding to the bin reflecting the measurement. For example, the stylus could transmit a frequency corresponding to bin 128 to reflect no tilt angle, and a frequency corresponding to bin 256 to reflect maximum tilt angle. It will be apparent to a person of skill in the art that the number of bins allocated and the purpose of the allocation may be selected depending on the needs of the system.

In an embodiment, a stylus may alternate between sending information corresponding to each parameter or measurement to be communicated. In an embodiment, the stylus may transmit each parameter or measurement for a period long enough to ensure that it is received during a single integration period. Thus, for example, where a 512 uSec integration period is required for stylus communication (e.g., an SIP, or the total of an SCIP and FCIP) the stylus may transmit its parameter or measurement for 1024 uSec—thereby ensuring that the signal fills an entire integration period. In an embodiment, a stylus will alternate the parameter or measurement being communicated at a rate of twice the integration period (e.g., SIP or SCIP plus FCIP). In an embodiment, where a stylus is configured to transmit multiple frequencies, a plurality of parameters or measurements may be sent simultaneously. Considerations of complexity and power (and thus cost and/or operation time) may require a design that transmits only or a small number of simultaneous frequencies.

On the sensor side, in an embodiment, if the value in an SOS bin is above a threshold (e.g., above a level of noise) it can be treated as information from the stylus. In the embodiment illustrated above, the SOS space may be predetermined to allocate any portion to any measurement or parameter.

In an embodiment, bits of data can be encoded using this technique, e.g., 4 bins can be used to represent 2 bits, 8 bins to represent 3 bits, 16 bins to represent 4 bits, 32 bins to represent 5 bits, 64 bins to represent 6 bits, 128 bins to represent 7 bits, 256 bins to represent 8 bits, and so on. To encode the data, in an embodiment, an over-threshold value in a bin would encode as a 1, and an under-threshold value in a bin would encode as a 0. The reverse would work as well. Thus, 2̂N bins represent N bits of data.

In addition to a stylus, a device (e.g. a card, mobile phone, etc.) can also transmit data through the display screen via encoding of digital information as discussed above with respect to the stylus signal. In an embodiment, the device information can be transmitted during the SIP. In an embodiment the device information can be encoded during the DIP. In an embodiment, the device information can be encoded during the FCIP, SCIP or both.

### Sub-Integration Period Utilization

As discussed above, a pen may have a limit on the number of simultaneous frequencies it can send, e.g., due to power/time or number of NCOs on pen (e.g., cost). In an embodiment, the integration period may be subdivided. In an embodiment, during a stylus integration period, the stylus can change frequencies, allowing the stylus to affect two or more bins during a single integration period. In an illustrative embodiment, consider a 512 uSec SIP. A pen capable of transmitting only one frequency at a time may transmit two pieces of information per SIP by transmitting each for one-half of the SIP. In other words, for example, a frequency corresponding to bin 10 may be transmitted for 256 uSec sub-period, and subsequently, a frequency corresponding to bin 128 may be transmitted for another 256 uSec sub-period. As above, because the pen may be asynchronous with the sensor, in an embodiment the above alternation from bin 10 to bin 128 may take place for two consecutive repetitions (e.g., a total of 1024 uSec.)

It will be apparent to a person of skill in the art in view of the foregoing that less magnitude will reach each of the bins corresponding to the shorter sub-period transmissions, however, provided the targeted bins are above a threshold (e.g., louder than noise), this technique can be used. In an embodiment, three sub-periods of approximately 171 uSec. are used during each SIP. In an embodiment, four sub-periods of 64 uSec. are employed. In an embodiment, the SIP or other integration period may be divided into an arbitrary number of sub-periods subject only to the constraint that each sub-period transmission is sufficient to cause the targeted bin have values above a threshold so that they are treated as information.

The capability to provide multiple values of information during a single integration period allows the use of encoded information. Thus, for example, a range of bins can represent a byte of data.

### Bin Amplitude Representing Multiple Bits

In an embodiment, a stylus can change the amplitude of its frequency, e.g., by changing the voltage associated with its transmission. In an embodiment, changes in amplitude can be detected as changes in the value of the corresponding bin. In an embodiment, the stylus can transmit a signal at two different amplitudes, e.g., half-power and full power, the half-power corresponding to a lower bin value. In an embodiment, two different thresholds are used in analysis of a bin, below the first, results in considering the value of the bin as empty (e.g., zero), while a value above the first threshold, but below the second can be considered as another value (e.g., 1), and a value above the second threshold can be considered yet another value (e.g., 2). In an embodiment, for a given frequency, a pen can have three amplitudes (0, half, full), or four amplitudes (0, one-third, two-thirds, full) or five amplitudes (0, one-quarter, one-half, three-quarters, full).

In an embodiment, the transmission time can be decreased to decrease the amplitude received by the touch controller. In an embodiment, the SIP is 512 uS. A frequency corresponding to bin 10 may be transmitted for a 256 uSec sub-period. This would cause the touch controller to receive half the amplitude at that bin. In an embodiment, for a given frequency, a pen can have three transmission times (0, 256, 512), or four transmission times (0, 170, 340, full), or five transmission times (0, 128, 256, 384, 512).

In an embodiment, the number of amplitudes for a frequency corresponds to the number of different values that can be detected in the corresponding bin. In an embodiment, a stylus may be configured to have an arbitrarily large number of amplitude values that can correspond to a different bin threshold, subject only to the constraint that each of the amplitudes is sufficient to cause the targeted bin to have a discrete range of values above a threshold so that they are treated as separate information. The use of bins having multiple values is akin to sending a number from 0 to one less than the number of values. For example, a bin that can be on or off transmits the equivalent of a 0 or 1; a bin that can be any of ten values can represent any number from 0 to 9. Similarly, where a bin can hold any of 8 values, it can be used to encode 3 bits of data. And where a bin can hold 16 values, it can be used to encode 4 bits of data. It is desirable to ensure that the number of bins is not so large as to cause ambiguity between the values represented.

### Bin Phase Used to Represent Bits of Information

In an embodiment, phase can be used to encoding bits of information where the stylus is synchronized with the sensor. In an embodiment, a stylus includes a receiver that can detect row signals. In the TIP/SIP configuration, row signals are present on the sensor during TIP and are not present on the sensor during SIP. Accordingly, the stylus can use its tip or another conductor to receive signals from the sensor when it is in proximity thereto. In an embodiment, the stylus synchronizes its phase encoding with the SIP cycle by detecting the transition between having and not having row signals present at its tip or other conductor.

Once synchronization is achieved, regardless of how it is achieved, in an embodiment, the stylus can use phase to communicate information or bits. In an embodiment, the stylus can invert every other frame, taking it 180 degrees out of phase. In an embodiment, increments of 180 degrees can encode 1 bits of information (breaking the IQ into 2 halves). In an embodiment, increments of 90 degrees can encode 2 bits of information (breaking the IQ into 4 quadrants).

As with the other techniques described above, an arbitrarily large number of phase changes can be used to encode more information, subject only to the constraint that each of the changes is sufficient to cause the targeted bin to have an IQ relationship that can be distinguished from other phase changes; in other words, the phase signal must be distinguishable from phase noise.

### Using Inter-Bin Frequencies to Encode Information

As discussed above, bin spacing is determined by the formula of number of samples divided by the sample rate. In an illustrative embodiment, 1024 bins are spaced by 2 KHz, with centers at e.g., 1.000 MHz, 1.002 MHz, 1.004 MHz, and so on. As discussed above, a pen can transmit at 1.000 MHz to drive the corresponding bin to a value above a threshold and therefore communicate a bit (e.g., a 1 as opposed to a 0) of information. Also as discussed above, the pen can vary the amplitude or phase of the transmission to potentially communicate additional information.

In an embodiment, the pen can vary the frequency transmitted to vary the information communicated. In an embodiment, the pen can use stops between two center frequencies to transmit data into two bins at once. As an illustration, consider that a pen transmits at 1.001 MHz; such a transmission will cause its effect to be split in two adjacent bins, i.e., the bins corresponding to 1.000 MHz and 1.002 MHz. Moreover, where the pen transmits at 1.0005 MHz, it will also cause its effect to split, but unequally into the two adjacent bins. Thus, using this effect, a pen can populate two adjacent bins with data by transmitting at a frequency between the frequency corresponding to the bins themselves—i.e., the center frequencies. In an embodiment, the ratio of the two bins can be used to express a value.

In an embodiment, the frequency is sent halfway between 2 bins adding an extra bit of information. In an embodiment, the frequencies are sent at increments of ¼ of the bin spacing adding an extra 2 bits of information. In an embodiment, logic thresholds to make logic determination of what the ratio of adjacent bins would signify may be based on the differential signal level as a ratio. E.g., 1:0=>0′b00, 0.75:0.25=>0′b01, 0.5:0.5=>0′b10, 0.25:0.75=>0′b11. In an embodiment, a discrete number of ratios is predefined. In an embodiment, hysteresis guard bands are employed around each ratio.

Similarly, two (or more) separate frequencies can each be transmitted for a period during an SIP, and the ratio of transmit time of each can be employed to create separate values for the two (as above). This way, like above, there is a split of energy in multiple bins, but they don't have to be adjacent.

It will be apparent to a person of skill in the art that the methods for transmitting data from a stylus to a touch screen can used during an SIP, TIP, FCIP, or SCIP. During an SIP, FCIP or SCIP, the frequency transmitted must also be used to determine the position of the stylus. In an embodiment, the data is transmitted during the TIP. During the SIP, a fixed frequency with a fixed amplitude and phase is transmitted to determine the position of the stylus.

An aspect of the disclosure is a sensor system. The sensor system comprising: a sensor having a plurality of first conductors and a plurality of second conductors, the sensor comprising; a receiver associated with each of the plurality of first conductors and each of the plurality of second conductors; a signal processor configured to: perform a measurement of the signals received by the receivers during a plurality of successive touch integration periods and stylus integration periods; identify touch events from the measurement of the signals received on the receivers during a touch integration period; determine the location of a stylus, and information transmitted by the stylus from the measurement of the signals received on the receivers during the stylus integration period or the touch integration period.

Another aspect of the disclosure is an active stylus system. The active stylus system comprising: a stylus adapted to transmit at least one signal during a stylus integration period; a sensor having a first plurality of conductors and a second plurality of conductors, the sensor comprising; a receiver associated with each of the first plurality of conductors and each of the second plurality of conductors; a signal processor configured to: perform a measurement of the signals received by the receivers during a plurality of successive interleaved touch integration periods and stylus integration periods; identify touch events from the measurement of the signals received on the receivers during a touch integration period; determine the location of the stylus, and information transmitted by the stylus from the measurement of the signals received on the receivers during the stylus integration period or the touch integration period.

Still yet another aspect of the disclosure is a sensor system comprising: a sensor having a first plurality of conductors and a second plurality of conductors, the sensor comprising; a receiver associated with each of the first plurality of conductors and the second plurality of conductors; a signal processor configured to: perform a measurement of the signals received by the receivers during a plurality of successive first combined integration periods and second combined integration periods; identify touch events from the measurement of the signals received on the receivers during a first combined integration period; determine the location of a stylus, and information transmitted by the stylus from the measurement of the signals received on the receivers during the second combined integration period or the first combined integration period.

The present systems are described above with reference to various embodiments and operational illustrations. It is understood that each embodiment block of the or operational illustrations, and combinations of blocks or operational illustrations, may be implemented by means of analog or digital hardware and computer program instructions. Computer program instructions may be provided to a processor of a general purpose computer, special purpose computer, ASIC, or other programmable data processing apparatus, such that the instructions, which execute via a processor of a computer or other programmable data processing apparatus, implements the functions/acts specified in the operational illustrations or blocks.

Except as expressly limited by the discussion above, in some alternate implementations, the functions/acts noted in the blocks may occur out of the order noted in the operational illustrations. For example, the order of execution if blocks shown in succession may in fact be executed concurrently or substantially concurrently or, where practical, any blocks may be executed in a different order with respect to the others, depending upon the functionality/acts involved.

While the invention has been particularly shown and described with reference to embodiment thereof, it will be understood by those skilled in the art that various changes in form and details may be made therein without departing from the spirit and scope of the inventions. The inventions disclosed herein are intended to have the full scope of protection as each is described in a claim.

1. A sensor system comprising:
a sensor having a plurality of first conductors and a plurality of second conductors, the sensor comprising;
a receiver associated with each of the plurality of first conductors and each of the plurality of second conductors;
a signal processor configured to:
perform a measurement of the signals received by the receivers during a plurality of successive touch integration periods and stylus integration periods;
identify touch events from the measurement of the signals received on the receivers during a touch integration period;
determine the location of a stylus, and information transmitted by the stylus from the measurement of the signals received on the receivers during the stylus integration period or the touch integration period.

2. The sensor system of claim 1, wherein the stylus integration periods are interleaved with the touch integration periods.

3. The sensor system of claim 1, wherein there are two stylus integration periods followed by one touch integration period.

4. The sensor system of claim 3, wherein during at least one of the two stylus integration periods information other than stylus writing information is conveyed.

5. The sensor system of claim 1, further comprising a device integration period following at least one of the touch integration periods or stylus integration periods.

6. The sensor system of claim 5, wherein the information transmitted to the sensor during the device integration period is financial information.

7. The sensor system of claim 1, wherein there are two touch integration periods followed by one stylus integration period.

8. The sensor system of claim 1, wherein during the stylus integration period signals are received on the first plurality of conductors and the second plurality of conductors.

9. An active stylus system comprising:
a stylus adapted to transmit at least one signal during a stylus integration period;
a sensor having a first plurality of conductors and a second plurality of conductors, the sensor comprising;
a receiver associated with each of the first plurality of conductors and each of the second plurality of conductors;
a signal processor configured to:
perform a measurement of the signals received by the receivers during a plurality of successive interleaved touch integration periods and stylus integration periods;
identify touch events from the measurement of the signals received on the receivers during a touch integration period;
determine the location of the stylus, and information transmitted by the stylus from the measurement of the signals received on the receivers during the stylus integration period or the touch integration period.

10. The active stylus system of claim 9, wherein the stylus is adapted to determine a skeletal model of a gripping hand.

11. The active stylus system of claim 9, wherein the stylus integration periods are interleaved with the touch integration periods.

12. The active stylus system of claim 9, wherein there are two stylus integration periods followed by one touch integration period.

13. The sensor system of claim 9, wherein there are two touch integration periods followed by one stylus integration period.

14. The sensor system of claim 9, wherein during the stylus integration period signals are received on the first plurality of conductors and the second plurality of conductors.

15. A sensor system comprising:
a sensor having a first plurality of conductors and a second plurality of conductors, the sensor comprising;
a receiver associated with each of the first plurality of conductors and the second plurality of conductors;
a signal processor configured to:
perform a measurement of the signals received by the receivers during a plurality of successive first combined integration periods and second combined integration periods;
identify touch events from the measurement of the signals received on the receivers during a first combined integration period;
determine the location of a stylus, and information transmitted by the stylus from the measurement of the signals received on the receivers during the second combined integration period or the first combined integration period.

16. The sensor system of claim 15, wherein during the first combined integration period a different orthogonal signal is transmitted down each of the first plurality of conductors.

17. The sensor system of claim 15, wherein during each first combined integration period touch events and stylus information is determined.

18. The sensor system of claim 15, wherein during the second combined integration period a different orthogonal signal is transmitted down each of the second plurality of conductors.

19. The sensor system of claim 15, wherein during the second combined integration period information regarding tilt is transmitted by the stylus.

20. The sensor system of claim 15, wherein during the second combined integration period information regarding pressure is transmitted by the stylus.
